(19) United States
(12) Patent Application Publication
(10) Pub. No.: US 2023/0177550 A1
(43) Pub. Date: Jun. 8, 2023

(54) PRIORITIZED PARTICIPATION IN A VERY IMPORTANT PERSON (VIP) EVENT EXPERIENCE

(71) Applicant: StageWood Consortium, Inc., Miami Beach, FL (US)

(72) Inventor: Santiago Figuereo, Miami, FL (US)

(21) Appl. No.: 17/542,104

(22) Filed: Dec. 3, 2021

(51) Int. Cl. G06Q 30/02; G06Q 10/02; G06Q 50/00

(52) U.S. Cl. CPC G06Q 30/0211; G06Q 10/02; G06Q 30/0224; G06Q 50/01

(57) ABSTRACT

Prioritized participation in a VIP event experience includes registering different members of a ticket distribution network and monitoring the Internet communications of each of the members in respect to content pertaining to different performers. Then, different metrics of interest can be computed in respect to the different performers for each of the registered different members. Consequently, an offer for sale can be published in respect to an event relating to one of the different performers and an awarding of the offer for sale to the event can be prioritized to one of the registered different members having a highest one of the computing metrics of interest in respect to the one of the different performers.

### BACKGROUND OF THE INVENTION

### Field of the Invention

The present invention relates to the field of concert promotion and more particularly to the crowd-sourced scheduling of a concert performance.

### Description of the Related Art

Concert promotion refers to the any portion of the process of planning, marketing and producing a live performance by an entertainer to a large group of spectators. While customarily associated with musical and comedic performances, concert promotion also encompasses orchestral performances, political and celebrity appearances, theater both traveling and fixed location, symphony, sporting events and live spectacles such as tradeshows, auto shows, air shows, boat shows and the like. The general features of concert promotion include the selection of a venue at a specific geographic location for use on a specific date, and the selection of one or more performers to perform at the selected venue on the specific date.

Much of concert promotion is reflects and exercise in scheduling in which the promoter selects a performer likely to draw a maximized audience willing to purchase an entrance ticket to the selected venue on the appointed date in order to experience the performance. The choice of venue largely depends upon the capacity of the venue and the ability for the selected performer to draw enough commercial interest in paying attendees to fill the available seats within the venue. As can be seen, then, for the concert goer, the ability to attend a concert performance of interest at a convenient time and date at a venue geographically proximate to the concert goer largely depends upon the choices of a single individual or small group of individuals charged with the responsibility to schedule concert performances irrespective of the precise identity of the chosen performer, selected venue and chosen date of the performance.

The task of arranging a concert performance, then, can be quite complex and given the seemingly vast number of available performance and the unprecedented diversity of taste amongst prospective concert goers, the task of optimally arranging a concert performance can be nearly impossible for such a small number of decision makers. Consequently, venues remain vacant, sub-optimally utilized, and so many prospective performers remain on the sidelines, untapped at times when the performer is otherwise able to perform. Most importantly, the consuming community of prospective concert goers remain unsatisfied in their inability to attend a live performance of an entertainer of choice at a venue of reasonable geographic proximity and on a date of convenience.

Notably, the inefficiencies of concert promotion are most evident with respect to social media. In social media, concert performers only once scheduled are promoted to social media participants known to have demonstrated consumer interest in concerts in general or in the merchandise of a particular performer through the use advertisement exchanges interacting with consumer information collected both by social media platforms and by search engines. Social media participants fervently interested in a particular performer are inclined to post social media content demonstrating such fervent interest irrespective of any promotion targeting those participants. But, tapping the fervent interest of those participants in promoting a specific performance heretofore has been limited to participants indicating on social media a planned attendance at an event and there remains no incentive for those participants to provide such information let alone engage in proactive promotion of the performance.

### BRIEF SUMMARY OF THE INVENTION

Embodiments of the present invention address technical deficiencies of the art in respect to concert promotion. To that end, embodiments of the present invention provide for a novel and non-obvious method for prioritized participation in a VIP event experience. Embodiments of the present invention also provide for a novel and non-obvious computing device adapted to perform the foregoing method. Finally, embodiments of the present invention provide for a novel and non-obvious data processing system incorporating the foregoing device in order to perform the foregoing method.

In one embodiment of the invention, a method for prioritized participation in a VIP event experience includes registering different members of a ticket distribution network and monitoring the Internet communications of each of the members in respect to content pertaining to different performers. Then, different metrics of interest can be computed in respect to the different performers for each of the registered different members. Consequently, an offer for sale can be published in respect to an event relating to one of the different performers and an awarding of the offer for sale to the event can be prioritized to one of the registered different members having a highest one of the computing metrics of interest in respect to the one of the different performers.

In one aspect of the embodiment, the Internet communications include social media postings onto a social network, but in another aspect of the embodiment, the Internet communications can include a reposting of a comment of a third party. In yet another aspect of the embodiment, the Internet communications can include an indication of appreciation electronically associated with a comment of a third party in a social media platform. As to the former, the metrics of interest can include a count of a number of instances in which each of the registered different members submits a posting to the social network mentioning the one of the different performers. As to the latter, the metrics of interest can include a count of indicia of appreciation received for each of the registered different members in respect to corresponding postings to the social network mentioning the one of the different performers.

In another embodiment of the invention, a data processing system is adapted for prioritized participation in a VIP event experience. The system includes a host computing platform having one or more computers, each with memory and one or processing units including one or more processing cores. The system also includes a prioritized participation module. The module includes computer program instructions enabled while executing in the memory of at least one of the processing units of the host computing platform to register different members of a ticket distribution network, to monitor Internet communications of each of the members in respect to content pertaining to different performers, to compute metrics of interest in respect to the different performers for each of the registered different members, to publish an offer for sale to an event relating to one of the different performers, and to prioritize an awarding of the offer for sale to the event to one of the registered different members having a highest one of the computing metrics of interest in respect to the one of the different performers.

In yet another embodiment of the invention, a computing device includes a non-transitory computer readable storage medium having program instructions stored therein. The instructions are executable by at least one processing core of a processing unit so as to cause the processing unit to register different members of a ticket distribution network, to monitor Internet communications of each of the members in respect to content pertaining to different performers, to compute metrics of interest in respect to the different performers for each of the registered different members, to publish an offer for sale to an event relating to one of the different performers, and to prioritize an awarding of the offer for sale to the event to one of the registered different members having a highest one of the computing metrics of interest in respect to the one of the different performers.

In this way, the technical deficiencies of the concert promotion are overcome owing to promotion of VIP status to those concert goers known to have a highest degree of affinity to a particular performer and, therefore, most likely to promote on social media a concert at which the particular performer will perform. Additional aspects of the invention will be set forth in part in the description which follows, and in part will be obvious from the description, or may be learned by practice of the invention. The aspects of the invention will be realized and attained by means of the elements and combinations particularly pointed out in the appended claims. It is to be understood that both the foregoing general description and the following detailed description are exemplary and explanatory only and are not restrictive of the invention, as claimed.

### BRIEF DESCRIPTION OF THE SEVERAL VIEWS OF THE DRAWINGS

The accompanying drawings, which are incorporated in and constitute part of this specification, illustrate embodiments of the invention and together with the description, serve to explain the principles of the invention. The embodiments illustrated herein are presently preferred, it being understood, however, that the invention is not limited to the precise arrangements and instrumentalities shown, wherein:

FIG. 1 is a pictorial illustration reflecting different aspects of a process of [statement of the invention];

FIG. 2 is a block diagram depicting a data processing system adapted to perform one of the aspects of the process of FIG. 1; and,

FIG. 3 is a flow chart illustrating one of the aspects of the process of FIG. 1.

### DETAILED DESCRIPTION OF THE INVENTION

Embodiments of the invention provide for prioritized participation in a VIP event experience. In accordance with an embodiment of the invention, the Internet communications, such as e-mail, chat messaging, social media postings and the like are monitored for each of several different registered individuals. Metrics are computed for the communications such as a frequency or count of postings in social media of determined positive sentiment, or even enthusiastic sentiment, relating to a specific performer. Then, upon scheduling a performance by the specific performer, those of the individuals determined to have a highest computed metric or set of metrics for the specific performer are messaged with an offer for VIP access to the scheduled performance, either by way of early access to the purchasing of an event ticket to the performance, or by providing access to VIP seating closest to the stage from which the performance will occur, or to pre- or post-performance meet and greet opportunities, or access to receive at no cost or low cost, select merchandise associated with the specific performer.

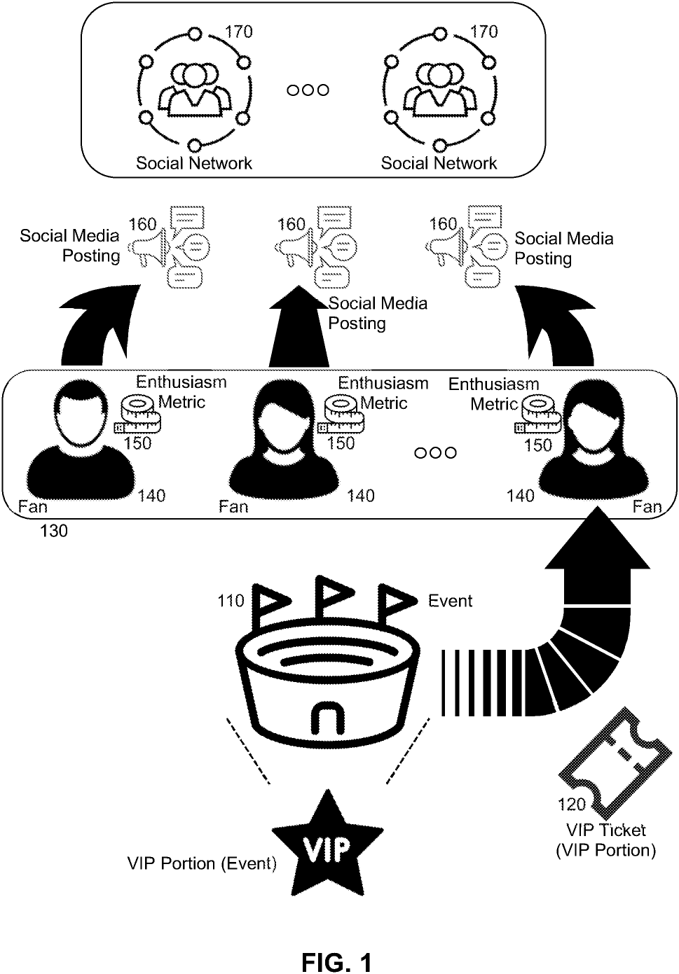

In illustration of one aspect of the embodiment, FIG. 1 pictorially shows a process of prioritized participation in a VIP event experience. As shown in FIG. 1, different fans 140 purchase an admission ticket to a performance 110 scheduled for a specific venue on a specific date. An identity of each of the fans is determined and, across a number of social media networks 170, the postings 160 of the fans 140 are observed, for instance by conducting automated queries for each of the fans 140 and parsing the profile postings of each of the fans 140 thereon. An enthusiasm metric 150 is then computed for each of the fans 140 corresponding to the relatedness between corresponding ones of the social media postings 160 onto the different social media networks 170 and the performance 110.

In this regard, the enthusiasm metric 150 can be computed based upon a number of the postings 160 posted to one or more of the social media networks 170 referencing a performer for the performance 110, a venue of the performance 110, a genre of the performance 110 or the performance 110 itself. As well, the enthusiasm metric 150 can be computed based upon a number of other individuals upvoting the postings 160 pertaining to the performance 110 by corresponding ones of the fans 140—-namely “likes” or the equivalent thereof. Further, the enthusiasm metric 150 can be computed based upon a count of re-postings of the postings 160 of others referencing aspects of the performance 110. Yet further, the enthusiasm metric 150 can be computed based upon a count of a number of upvotes issued by individual ones of the fans 140 for postings 160 of others of the fans 140 relating to the performance 110.

Different weighted combinations can be applied in order to compute the enthusiasm metric such as weighting more heavily direct ones of the postings 160 of the fans 140 relating to the performance, but weighting less heavily upvotes of the postings 170 of others of the fans 140 relating to the performance, and even weighting substantially more heavily the direct ones of the postings 160 when those direct ones of the postings 160 are either present on multiple, different ones of the social networks 170, or when those postings 160 are upvoted by others of the fans 140. Thereafter, a portion of the performance 110 determined to be a VIP portion 130 and thus limited to a subset of the fans 140 is reserved only for one or more of the fans 140 determined to have a highest corresponding enthusiasm metric 150 and, in consequence, only a subset of those fans 140 are offered an admissions ticket 120 to the VIP portion 130.

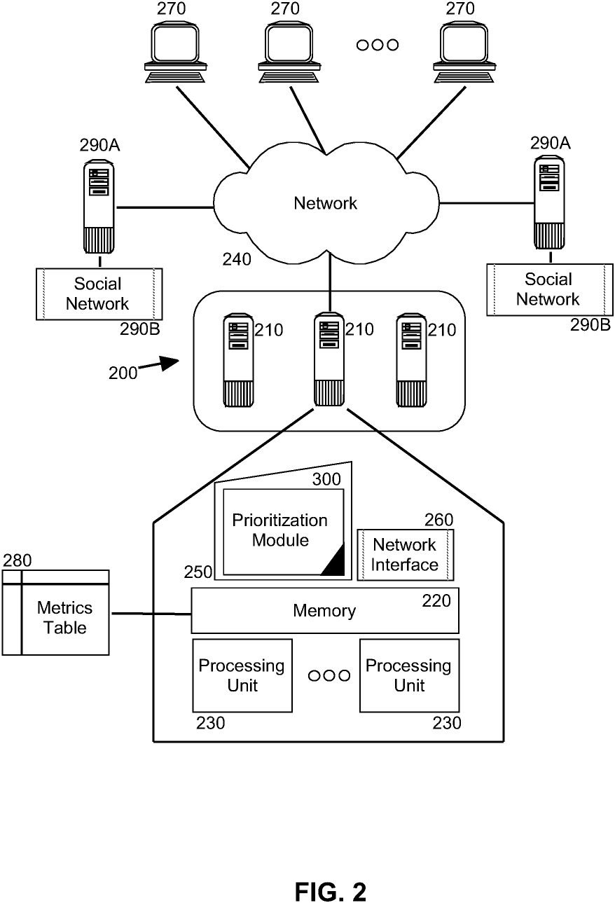

Aspects of the process described in connection with FIG. 1 can be implemented within a data processing system. In further illustration, FIG. 2 schematically shows a data processing system adapted to perform prioritized participation in a VIP event experience. In the data processing system illustrated in FIG. 1, a host computing platform 200 is provided. The host computing platform 200 includes one or more computers 210, each with memory 220 and one or more processing units 230. The computers 210 of the host computing platform (only a single computer shown for the purpose of illustrative simplicity) can be co-located within one another and in communication with one another over a local area network, or over a data communications bus, or the computers can be remotely disposed from one another and in communication with one another through network interface 260 over a data communications network 240.

Notably, a computing device 250 including a non-transitory computer readable storage medium can be included with the data processing system 200 and accessed by the processing units 230 of one or more of the computers 210. The computing device stores 250 thereon or retains therein a program module 300 that includes computer program instructions which when executed by one or more of the processing units 230, performs a programmatically executable process for prioritized participation in a VIP event experience. Specifically, the program instructions during execution monitor the social media postings to different social networks 290B hosted in different computing servers 290A from over the data communications network 240. More specifically, the program instructions query each of the different social networks 290B for each of the fans in order to parse the profile pages of those fans and to detect different postings by the different fans relating to the scheduled performance.

The program instructions then compute, for each of the fans, an enthusiasm metric based upon the number and nature of the postings and the program instructions store the enthusiasm metric for each of the fans in a metrics table 280 disposed within the memory 220. Based upon the different enthusiasm metrics for corresponding ones of the fans stored in the metrics table 280, the program instructions select one or more of the fans with the highest respective values for the enthusiasm metrics and transmit to a remote computing device 270 of each of the selected fans, an offer to attend a VIP portion of the scheduled event open to only a smaller subset of fans attending the scheduled event.

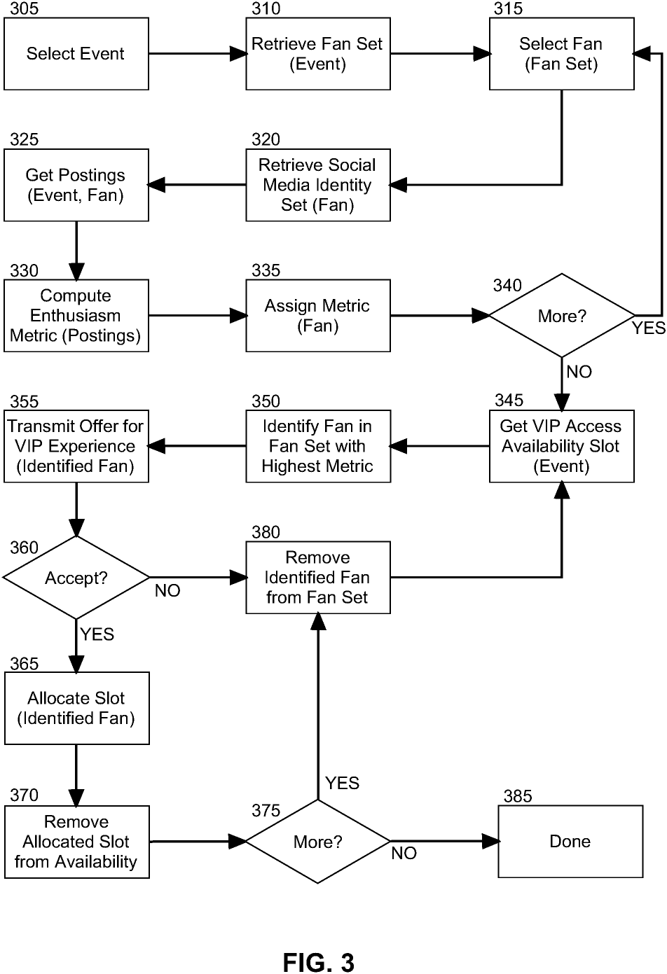

In further illustration of an exemplary operation of the module, FIG. 3 is a flow chart illustrating one of the aspects of the process of FIG. 1. Beginning in block 305, a scheduled event is selected for VIP prioritization and in block 310, a set of fans registered for the scheduled event are retrieved. Then, in block 315, a first one of the fans in the set is selected and in block 320 a social media identity set determined for the selected one of the fans—-namely a screen ID or user ID associated with the first one of the fans in each of one or more social networks. In block 325, all of the social media postings in each of the social media networks determined to relate to the schedule event are retrieved and processed in order to compute an enthusiasm score in block 330. Then, the computed enthusiasm metric is assigned to the first one of the fans. In decision block 340, if additional fans in the set remain to be processed, the process returns to block 315.

In decision block 340, one no fans remain to be processed in the set, in block 345 one or more available spaces in a VIP portion of the scheduled event is selected for allocation to one or more corresponding ones of the fans in the set. To that end, in block 350, a fan in the set having a highest corresponding enthusiasm metric is identified and in block 355, an offer is transmitted to the identified fan to attend the VIP portion of the scheduled event. In decision block 360, if the identified fan accepts the offer, in block 365 the available space is allocated to the identified fan and removed from a selection of allocatable available spaces in block 370. In contrast, in decision block 360 if the identified fan fails to accept the offer, the identified fan is removed from the set.

In the former instance, in decision block 375 if it is determined that additional available spaces remain to be allocated, in block 380 the identified fan is removed from the set of fans and the process returns to block 345 in which the next available, allocatable space to the VIP portion of the scheduled event is selected for allocation to the fan remaining in the set having the highest enthusiasm metric. However, in decision block 375, when no further available spaces remain to be allocated, the process ends in block 385.

Of import, the foregoing flowchart and block diagram referred to herein illustrate the architecture, functionality, and operation of possible implementations of systems, methods, and computing devices according to various embodiments of the present invention. In this regard, each block in the flowchart or block diagrams may represent a module, segment, or portion of instructions, which includes one or more executable instructions for implementing the specified logical function or functions. In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

More specifically, the present invention may be embodied as a programmatically executable process. As well, the present invention may be embodied within a computing device upon which programmatic instructions are stored and from which the programmatic instructions are enabled to be loaded into memory of a data processing system and executed therefrom in order to perform the foregoing programmatically executable process. Even further, the present invention may be embodied within a data processing system adapted to load the programmatic instructions from a computing device and to then execute the programmatic instructions in order to perform the foregoing programmatically executable process.

To that end, the computing device is a non-transitory computer readable storage medium or media retaining therein or storing thereon computer readable program instructions. These instructions, when executed from memory by one or more processing units of a data processing system, cause the processing units to perform different programmatic processes exemplary of different aspects of the programmatically executable process. In this regard, the processing units each include an instruction execution device such as a central processing unit or “CPU” of a computer. One or more computers may be included within the data processing system. Of note, while the CPU can be a single core CPU, it will be understood that multiple CPU cores can operate within the CPU and in either instance, the instructions are directly loaded from memory into one or more of the cores of one or more of the CPUs for execution.

Aside from the direct loading of the instructions from memory for execution by one or more cores of a CPU or multiple CPUs, the computer readable program instructions described herein alternatively can be retrieved from over a computer communications network into the memory of a computer of the data processing system for execution therein. As well, only a portion of the program instructions may be retrieved into the memory from over the computer communications network, while other portions may be loaded from persistent storage of the computer. Even further, only a portion of the program instructions may execute by one or more processing cores of one or more CPUs of one of the computers of the data processing system, while other portions may cooperatively execute within a different computer of the data processing system that is either co-located with the computer or positioned remotely from the computer over the computer communications network with results of the computing by both computers shared therebetween.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

Having thus described the invention of the present application in detail and by reference to embodiments thereof, it will be apparent that modifications and variations are possible without departing from the scope of the invention defined in the appended claims as follows:

1. A method for prioritized participation in a VIP event experience comprising:
selecting an event for VIP prioritization and retrieving a fan set of fans that are registered for the event;
for each one of the fans in the set:
determining a screen ID for the one of the fans;
querying multiple different social networks over a computer communications network for all Internet communications by the one of the fans based upon the screen ID and that relate to the selected event; and,
computing an enthusiasm score for the Internet communications and assigning the computed enthusiasm score to the one of the fans in a metrics table;
determining a number of available spaces in a VIP portion of the event;
selecting a same number of the fans with highest corresponding enthusiasm scores; and,
publishing an offer for sale to the selected event to each of the number of the fans; and.

2. The method of claim 1, wherein the Internet communications comprises social media postings onto a corresponding one of the social networks.

3. The method of claim 1, wherein the Internet communications comprises a reposting of a comment of a third party.

4. The method of claim 2, wherein the enthusiasm score comprises a count of a number of submits a posting to one of the social networks mentioning a performer for the selected event.

5. The method of claim 2, wherein the enthusiasm score comprises a count of indicia of appreciation received for the one of the fans in respect to corresponding postings to the social networks mentioning a performer for the selected event .

6. A data processing system adapted for prioritized participation in a VIP event experience, the system comprising:
a host computing platform comprising one or more computers, each with memory and one or processing units including one or more processing cores; and,
a prioritized participation module comprising computer program instructions enabled while executing in the memory of at least one of the processing units of the host computing platform to perform:
selecting an event for VIP prioritization and retrieving a fan set of fans that are registered for the event;
for each one of the fans in the set:
determining a screen ID for the one of the fans;
querying multiple different social networks over a computer communications network for all Internet communications by the one of the fans based upon the screen ID and that relate to the selected event; and,
computing an enthusiasm score for the Internet communications and assigning the computed enthusiasm score to the one of the fans in a metrics table;
determining a number of available spaces in a VIP portion of the event;
selecting a same number of the fans with highest corresponding enthusiasm scores; and,
to each of the number of the fans; and.

7. The system of claim 1, wherein the Internet communications comprises social media postings onto a corresponding one of the social networks.

8. The system of claim 1, wherein the Internet communications comprises a reposting of a comment of a third party.

9. The system of claim 7, wherein the enthusiasm score comprises a count of a number of instances in which the one of the fans submits a posting to one of the social networks mentioning a performer for the selected event.

10. The system of claim 7, wherein the enthusiasm score comprises a count of indicia of appreciation received for the one of the fans in respect to corresponding postings to the social networks mentioning a performer for the selected event.

11. A computing device comprising a non-transitory computer readable storage medium having program instructions stored therein, the instructions being executable by at least one processing core of a processing unit to cause the processing unit to perform a method for prioritized participation in a VIP event experience, the method including:
selecting an event for VIP prioritization and retrieving a fan set of
for each one of the fans in the set:
determining a screen ID for the one of the fans;
queryin m multiple different social networks over a computer communications network for all Internet communications by the one of the fans based upon the screen ID and that relate to the selected event; and,
computing an enthusiasm score for the Internet communications and assigning the computed enthusiasm score to the one of the fans in a metrics table;
determining a number of available spaces in a VIP portion of the event;
selecting a same number of the fans with highest corresponding enthusiasm scores; and,
publishing an offer for sale to the selected event to each of the number of the fans; and.

12. The device of claim 11, wherein the Internet communications comprises social media postings onto a corresponding one of the social networks.

13. The device of claim 11, wherein the Internet communications comprises a reposting of a comment of a third party.

14. The device of claim 12, wherein the enthusiasm score comprises a count of a number of instances in which the one of the fans submits a posting to one of the social networks mentioning a performer for the selected event .

15. The device of claim 12, wherein the enthusiasm score comprises a count of indicia of appreciation received for the one of the fans in respect to corresponding postings to the social networks mentioning a performer for the selected event.
